(19) United States
(12) Patent Application Publication
(10) Pub. No.: US 2016/0155420 A1
(43) Pub. Date: Jun. 2, 2016

(54) ELECTRONIC APPARATUS AND CONTROLLING METHOD THEREOF

(71) Applicant: Samsung Electronics Co., Ltd., Suwon-si (KR)

(72) Inventors: Jin LA, Suwon-si (KR); Yong-gook PARK, Yongin-si (KR); Pil-seung YANG, Seoul (KR)

(21) Appl. No.: 14/952,214

(22) Filed: Nov. 25, 2015

(30) Foreign Application Priority Data
Nov. 27, 2014 (KR) 10-2014-0167418

(51) Int. Cl. G09G 5/12; G06F 3/14; G06F 3/0484; G09G 5/00

(52) U.S. Cl. CPC G09G 5/12; G09G 5/003; G06F 3/1423; G06F 3/04847; G09G 2370/06; G09G 2354/00

(57) ABSTRACT

An electronic apparatus and a controlling method thereof are provided. The electronic apparatus includes a communicator configured to transmit/receive a signal to/from another electronic apparatus and a controller configured to receive first information of the other electronic apparatus, the first information including a device identification information and a function identification information corresponding to a function being executed in the other apparatus, and control the communicator to transmit second information for pairing with the other apparatus to connect to the other electronic apparatus, to the other electronic apparatus, if the function being executed in the other apparatus is controllable in the electronic apparatus. Accordingly, a user may determine whether another electronic apparatus is a controllable apparatus, connect to another electronic apparatus easily based on the result of the determination, and control the connected another electronic apparatus.

### CROSS-REFERENCE TO RELATED APPLICATION(S)

This application claims the benefit under 35 U.S.C. §119(a) of a Korean patent application filed on Nov. 27, 2014 in the Korean Intellectual Property Office and assigned Serial No. 10-2014-0167418, the entire disclosure of which is hereby incorporated by reference.

### TECHNICAL FIELD

The present disclosure relates to an electronic apparatus and a controlling method thereof. More particularly, the present disclosure relates to an electronic apparatus capable of controlling another electronic apparatus and a controlling method thereof.

### BACKGROUND

Recently, there are many cases where an electronic apparatus is used to control another electronic apparatus. For example, it is possible to control a smart television (TV) using a smart phone.

In addition, with the development of various types of electronic apparatuses, a user often carries more than one electronic apparatus at the same time. And several electronic apparatuses may be controlled by a user in some temporary spaces such as a house or an office.

In such cases, it is difficult for a user to recognize which other electronic apparatus, from among various electronic apparatuses, can be controlled by the electronic apparatus which the user is currently using. In addition, when there are a plurality of controllable electronic apparatuses, separate programs such as applications to control each electronic apparatus should be downloaded, which causes inconvenience.

Accordingly, a method of easily determining other apparatuses which are controllable by an electronic apparatus, connecting to the other apparatuses and controlling the other apparatuses which are connected is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus capable of determining whether other electronic apparatuses are controllable, connecting to other electronic apparatuses based on the result of the determination, and controlling the other electronic apparatuses and a controlling method thereof.

In accordance with an aspect of the present disclosure, an electronic apparatus is provided. The electronic apparatus includes a communicator configured to transmit/receive a signal to/from another electronic apparatus and a controller configured to receive first information of the other electronic apparatus, the first information including a device identification information and a function identification information corresponding to a function being executed in the other apparatus, and control the communicator to transmit second information for pairing with the other apparatus to connect to the other electronic apparatus, to the other electronic apparatus, if the function being executed in the other apparatus is controllable in the electronic apparatus.

The apparatus may further include a display configured to, in response to the other electronic apparatus being controllable by the electronic apparatus, display a user interface (UI) to receive a command to connect to the other electronic apparatus, and the controller, in response to receiving the connection command through the UI, may control the communicator to transmit the second information for pairing with the other apparatus.

The controller, in response to receiving information that the other electronic apparatus is paired from the other electronic apparatus and another electronic apparatus which is different from the other electronic apparatus, may stop displaying the UI to receive a command to connect to the other electronic apparatus.

The controller may determine whether the other electronic apparatus is connectable and whether a function of the other electronic apparatus is controllable by the electronic apparatus based on the first information to determine whether the other electronic apparatus is controllable by the electronic apparatus.

The apparatus may further include a display configured to, in response to the other electronic apparatus being paired, display a control UI to control the other electronic apparatus.

The communicator, in response to the other electronic apparatus being paired, may receive information regarding controlling of a function of the other electronic apparatus from the other electronic apparatus, and the controller may control the display to display a control UI corresponding to the received information.

The information regarding controlling of a function may be at least one of a UI image, a function code to control a function of the other electronic apparatus and uniform resource locator (URL) address information to download the UI image.

The communicator may transmit/receive a signal to/from a plurality of other electronic apparatuses, and the controller may analyze the first information received from each of the plurality of other electronic apparatuses to determine each of the plurality of other electronic apparatuses is controllable by the electronic apparatus, and control the communicator to transmit the second information to another electronic apparatus selected by a user from among the plurality of other electronic apparatuses which are controllable by the electronic apparatus.

The apparatus may further include a display configured to display a UI to select one of the plurality of other controllable apparatuses, and the controller may control the communicator to transmit the second information to the selected other electronic apparatus.

In accordance with another aspect of the present disclosure, a controlling method of an electronic apparatus is provided. The controlling method includes receiving first information from another electronic apparatus, the first information including a device identification information and a function identification information corresponding to a function being executed in the other apparatus, and transmitting second information for pairing with the other apparatus to connect to the other electronic apparatus, to the other electronic apparatus, if the function being executed in the other apparatus is controllable in the electronic apparatus.

The method may further include, in response to the other electronic apparatus being controllable by the electronic apparatus, displaying a UI to receive a command to connect to the other electronic apparatus, and the transmitting may include, in response to receiving the connection command through the UI, transmitting the pairing signal.

The displaying of the UI may further include, in response to receiving information that the other electronic apparatus is paired from the other electronic apparatus and another electronic apparatus which is different from the other electronic apparatus, stopping the displaying of the UI to receive a command to connect to the other electronic apparatus.

The determining may include determining whether the other electronic apparatus is connectable and whether a function of the other electronic apparatus is controllable by the electronic apparatus based on the first information to determine whether the other electronic apparatus is controllable by the electronic apparatus.

The method may further include, in response to the other electronic apparatus being paired, displaying a control UI to control the other electronic apparatus.

The displaying of the control UI may include, in response to the other electronic apparatus being paired, receiving information regarding controlling of a function of the other electronic apparatus from the other electronic apparatus, and displaying a control UI corresponding to the received information.

The information regarding controlling of a function may be at least one of a UI image, a function code to control a function of the other electronic apparatus and URL address information to download the UI image.

The receiving may include transmitting/receiving a signal to/from a plurality of other electronic apparatuses, the determining may include analyzing the first information received from each of the plurality of other electronic apparatuses to determine each of the plurality of other electronic apparatuses is controllable by the electronic apparatus, and the transmitting may include transmitting the second information to another electronic apparatus selected by a user from among the plurality of other electronic apparatuses which are controllable by the electronic apparatus.

The method may further include displaying a UI to select one of the plurality of other controllable apparatuses, and the transmitting may include transmitting the second information to the selected other electronic apparatus.

According to the various embodiments, a user may easily determine whether another electronic apparatus is a controllable apparatus, connect to the other electronic apparatus based on the result of the determination, and use the other controllable electronic apparatus.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are views illustrating an electronic apparatus and other electronic apparatuses according to various embodiments of the present disclosure;

FIG. 2 is a block diagram illustrating a configuration of a display apparatus according to an embodiment of the present disclosure;

FIG. 3 is a block diagram illustrating a configuration of a display apparatus according to an embodiment of the present disclosure;

FIGS. 4A, 4B, 4C, 4D, and 4E are views provided to explain a method of displaying a user interface (UI) of an electronic apparatus and other electronic apparatuses and a connecting method thereof according to various embodiments of the present disclosure;

FIGS. 5A, 5B, and 5C are views provided to explain a method of displaying a UI in an electronic apparatus according to a function of other electronic apparatuses according to various embodiments of the present disclosure;

FIGS. 6A, 6B, 6C, 6D, 6E, 6F, 6G, 6H, and 6I are views provided to explain a method where each of a plurality of electronic apparatuses controls at least one of the other apparatuses according to various embodiments of the present disclosure;

FIG. 7 is a flowchart illustrating a method in which an electronic apparatus connects to another electronic apparatus according to an embodiment of the present disclosure; and

FIG. 8 is a flowchart illustrating a controlling method of an electronic apparatus according to an embodiment of the present disclosure.

Throughout the drawings, it should be noted that like reference numbers are used to depict the same or similar elements, features, and structures.

### DETAILED DESCRIPTION

The following description with reference to accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In embodiments of the present disclosure, relational terms such as first and second, and the like, may be used to distinguish one entity from another entity, without necessarily implying any actual relationship or order between such entities.

The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

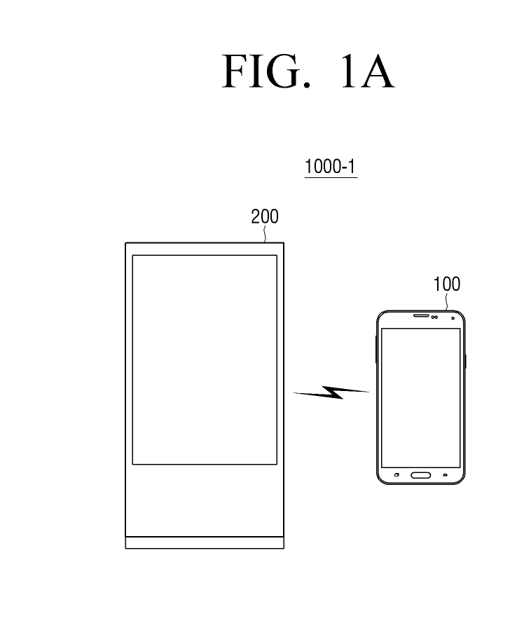

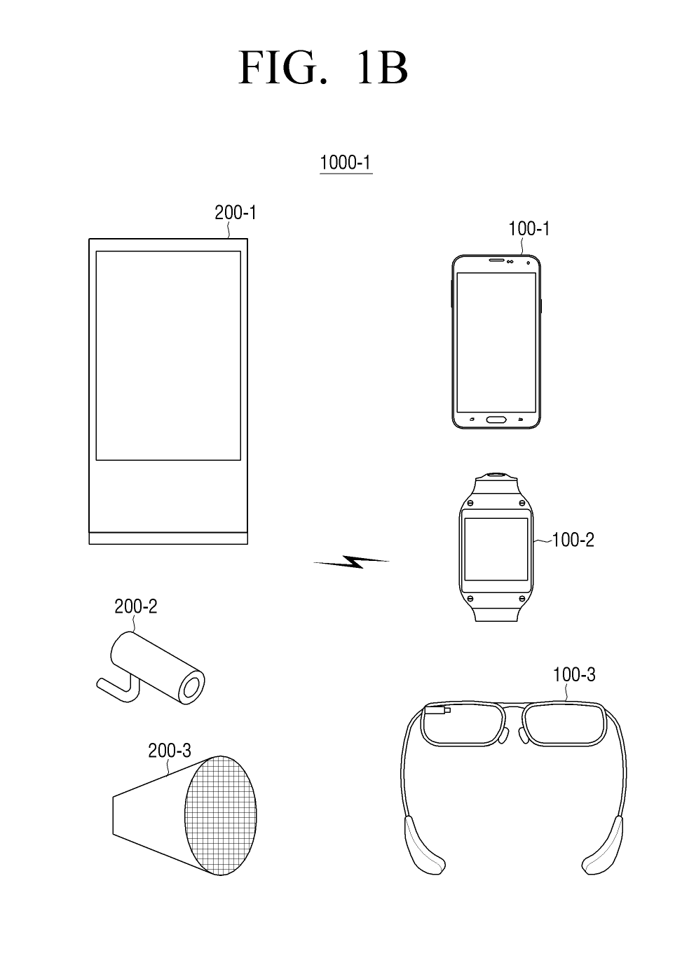

FIGS. 1A and 1B are views illustrating an electronic apparatus and other electronic apparatuses according to various embodiments of the present disclosure.

Referring to FIGS. 1A and 1B, the electronic apparatus system 1000-1 may include an electronic apparatus 100 and the other electronic apparatus 200. FIG. 1A illustrates that the electronic apparatus 100 is a mobile phone, and the other electronic apparatus 200 is a large format display (LFD), but this is only an example. The electronic apparatus 100 and the other electronic apparatus 200 may be realized as any kind of electronic apparatus regardless of their types.

For example, the other electronic apparatus 200 may be realized as an electronic apparatus such as a television (TV), a refrigerator, a washing machine, etc. in a house. Alternatively, the other electronic apparatus 200 may be realized as an electronic apparatus such as an LFD, a TV, a closed-circuit television (CCTV), a locking device of a house or an office, etc.

Meanwhile, the electronic apparatus may be a small electronic apparatus which is configured to receive a user's manipulation command easily. For example, the electronic apparatus 100 may be realized in the form of a mobile phone, a notebook personal computer (PC), a tablet PC, smart glasses, a smart watch or a smart ring, etc.

FIG. 1B illustrates an electronic apparatus system 1000-2 including a plurality of other electronic apparatuses 200-1, 200-2, 200-3 and a plurality of electronic apparatuses 100-1, 100-2, 100-3. In other words, there may be more than two electronic apparatuses 100 and other electronic apparatuses 200, respectively.

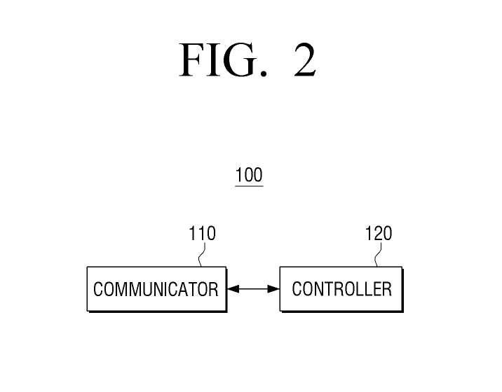

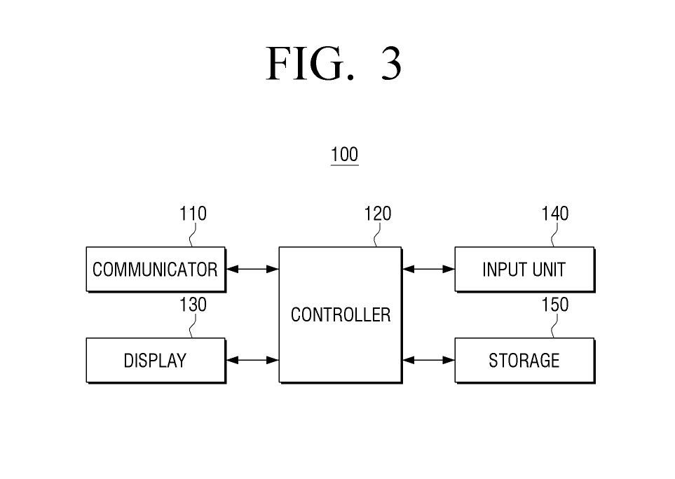

Hereinafter, the electronic apparatus 100 capable of controlling at least one of the other electronic apparatuses will be described with reference to FIGS. 2 and 3.

FIG. 2 is a block diagram illustrating configuration of the display apparatus briefly according to an embodiment of the present disclosure.

Referring to FIG. 2, the electronic apparatus 100 may include a communicator 110 and a controller 120.

The communicator 110 transmits/receives a signal to/from the other electronic apparatus 200 according to various types of communication methods. In other words, the communicator 110 may include various types of communication modules, and may perform communication with an electronic apparatus which exists outside the electronic apparatus 100, such as the other electronic apparatus 200.

The communicator 110 may perform communication with a plurality of other electronic apparatus simultaneously or sequentially.

The controller 120 controls the overall operations of the electronic apparatus 100. For example, the controller 120 may analyze apparatus identification information of the other electronic apparatus 200, which is included in a signal received from the other electronic apparatus 200 through the communicator 110. The controller 120 may determine whether the other electronic apparatus 200 is controllable by the electronic apparatus 100.

If the other electronic apparatus 200 is controllable by the electronic apparatus 100, the controller 120 may control the communicator 110 to transmit a pairing signal to connect to the other electronic apparatus 200, to the other electronic apparatus 200.

More specifically, the controller 120 may determine whether the other electronic apparatus 200 is connectable based on identification information of the other electronic apparatus 200 included in a received signal. In addition, the controller 120 may determine the function of the other electronic apparatus 200 is controllable by the electronic apparatus 100. Accordingly, if the other electronic apparatus 200 is a connectable apparatus and its functions are controllable by the electronic apparatus 100, the controller 120 may determine that the other electronic apparatus 200 is a controllable apparatus.

Meanwhile, if a signal is received from a plurality of other electronic apparatuses through the communicator 110, the controller 120 may analyze apparatus identification information included in a signal received from each of the plurality of other electronic apparatuses to determine whether each of the plurality of other electronic apparatuses is controllable by the electronic apparatus 100.

The controller 120 may control the communicator 110 to transmit a pairing signal to another electronic apparatus selected by a user from among the plurality of other electronic apparatuses which are controllable by the electronic apparatus 100.

FIG. 3 is a block diagram illustrating a configuration of a display apparatus according to an embodiment of the present disclosure.

Referring to FIG. 3, the electronic apparatus 100 may include not only the communicator 110 and the controller 120 but also a display 130, an input unit 140, and a storage 150. FIG. 3 illustrates various elements in a comprehensive manner, assuming that the electronic apparatus 100 provides various functions such as a display function, a function to control other electronic apparatuses, a communication function, a user voice recognition function, a video play function, a display function, etc. Accordingly, depending on various embodiments, some of the elements illustrated in FIG. 3 may be omitted or changed, and other elements may be added. The descriptions regarding elements which have already been described above will be omitted.

The communicator 110 may receive a signal which is broadcast from the other electronic apparatus 200.

More specifically, the other electronic apparatus 200 may broadcast a receivable signal with respect to any electronic apparatus via network as long as the electronic apparatus is different from the other electronic apparatus 200. According to an embodiment, the signal may be broadcast through network such as wireless fidelity (Wi-Fi) network, Bluetooth network, cellular network, etc.

The communicator 110 may include various communication modules such as a Bluetooth module, a Wi-Fi module, a near field communication (NFC) module, or a wireless communication module. Accordingly, the electronic apparatus 100 may user various communication modules included in the communicator 110 to receive a signal which is broadcast by the other electronic apparatus 200.

Meanwhile, the signal which is received from the other electronic apparatus 200 through the communicator 110 may include apparatus identification information of the other electronic apparatus 200. Accordingly, the controller 120 may analyze the apparatus identification information to determine whether the other electronic apparatus 200 is controllable by the electronic apparatus 100.

If it is determined that the other electronic apparatus 200 is controllable by the electronic apparatus 100, the controller 120 may control the communicator 110 to transmit a pairing signal to connect to the other electronic apparatus 200 to the other electronic apparatus 200.

More specifically, the controller 120 may determine whether the other electronic apparatus 200 is a connectable apparatus based on the identification information of the other electronic apparatus 200 included in the received signal. Subsequently, the controller 120 may determine whether the function of the other electronic apparatus 200 is controllable by the electronic apparatus 100. If the other electronic apparatus 200 is a connectable apparatus and is controllable by the electronic apparatus 100, the controller 120 may determine that the other electronic apparatus 200 is a controllable apparatus.

If it is determined that the other electronic apparatus 200 is an apparatus controllable by the electronic apparatus 100, the controller 120 may control to transmit a pairing signal to the other electronic apparatus 200 using a communication method through which the other electronic apparatus 200 broadcasts a signal including apparatus identification information.

Meanwhile, the electronic apparatus 100 may include the display 130. The display 130 displays various user interfaces (UIs) and contents. The display 130 may not be provided according to the type and shape of the electronic apparatus 100. For example, if the electronic apparatus 100 is a smart ring, the display 130 may not be provided.

If it is determined by the controller 120 that the other electronic apparatus 200 is controllable by the electronic apparatus 100, the display 130 may display a UI for receiving a connection command with respect to the other electronic apparatus 200. In other words, the display 130 may inform a user that there is the other electronic apparatus 200 which is connectable, and display a UI for receiving a connection command with respect to the other electronic apparatus 200 from the user.

Meanwhile, the input unit 140 receives a user command. The input unit 140 may receive a touch command through the display 130. In addition, the input unit 140 may be configured in the form of a button, a toggle, or a switch outside the other electronic apparatus 200 and receive a user command.

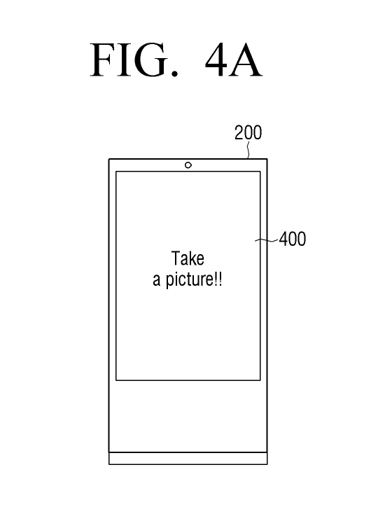

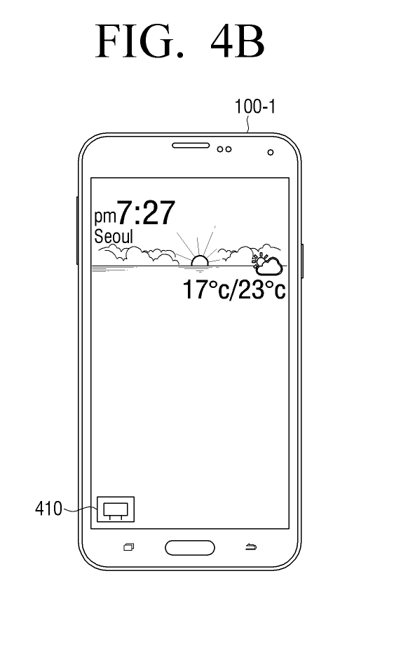

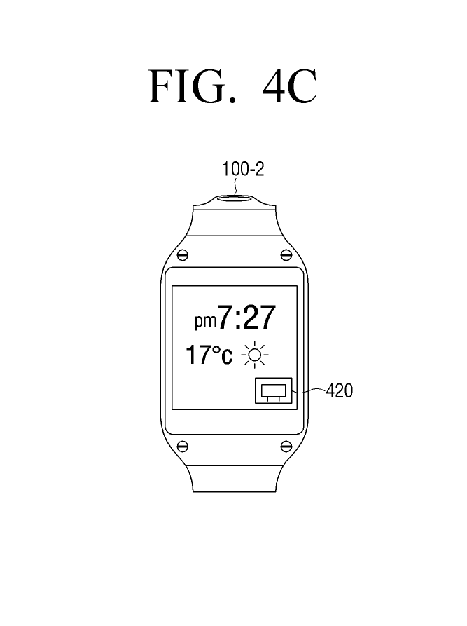

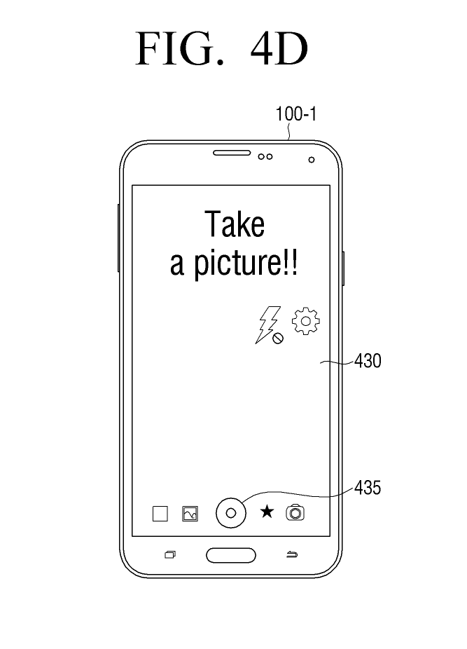

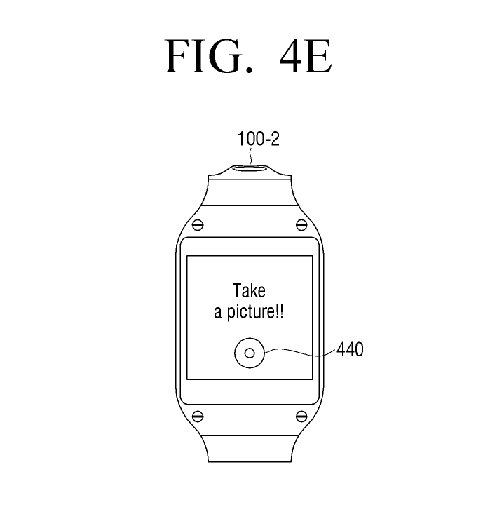

FIGS. 4A, 4B, 4C, 4D, and 4E are views provided to explain a method of displaying a UI of an electronic apparatus and other electronic apparatuses and a connecting method thereof according to various embodiments of the present disclosure.

FIG. 4A illustrates an embodiment in which the other electronic apparatus 200, which is realized as an LFD and performs a photographing function, is controllable by an electronic apparatus 100-1 which is realized as a smart phone.

The other electronic apparatus 200 illustrated in FIG. 4A broadcasts apparatus identification information including identification for identifying the other electronic apparatus 200 and information regarding a function (that is, a photographing function) performed by the other electronic apparatus 200. In other words, the other electronic apparatus 200 may broadcast a signal including apparatus identification information regardless of the type of received electronic apparatus according to every possible communication method.

FIG. 4B illustrates the electronic apparatus 100-1 which is realized as a smart phone according to an embodiment. If it is determined that the other electronic apparatus 200 is a controllable apparatus based on the analysis on apparatus identification information received from the other electronic apparatus 200, the electronic apparatus 100-1 which is realized as a smart phone may display a UI 410 for receiving a connection command on part of the display.

The electronic apparatus 100-1 which is realized as a smart phone may determine whether the other electronic apparatus 200 is a connectable apparatus through the identification. Even if the other electronic apparatus 200 is a connectable apparatus, the function performed by the other electronic apparatus 200 may not be controllable by the electronic apparatus 100-1 which is realized as a smart phone. Accordingly, the electronic apparatus 100-1 may determine whether the functions of the other electronic apparatus 200 are controllable based on the information regarding the functions performed by the other electronic apparatus 200. If it is determined that the functions currently performed in the other electronic apparatus 200 are controllable by the electronic apparatus 100-1, the electronic apparatus 100-1 may display the UI 410 for receiving a connection command.

In other words, if a touch command of touching the UI 410 for receiving a connection command using a user's finger is input, or a touch command is input using an apparatus such as a stylus pen, the electronic apparatus 100-1 may control the communicator 110 to transmit a pairing signal to the other electronic apparatus 200.

Meanwhile, there is no limit to an electronic apparatus which receives a signal broadcast from the other electronic apparatus 200. Accordingly, referring to FIG. 4C, if a smart watch 100-2 receives a signal from the other electronic apparatus 200, the smart watch 100-2 may also receive the signal from the other electronic apparatus 200 and analyze the signal.

If it is determined that the other electronic apparatus 200 is a controllable apparatus, the smart watch 100-2 may also display a UI 420 for receiving a connection command on part of the display.

If a touch command of touching the UI 440 for receiving a connection command using a user's finger is input, or a touch command is input using an apparatus such as a stylus pen, the smart watch 100-2 may control the communicator 110 to transmit a pairing signal to the other electronic apparatus 200.

In addition, if a button, a key, a toggle, etc. for confirmation exists outside the smart watch 100-2, then a user may display the UI for receiving a connection command and input a connection command with respect to the other electronic apparatus 200 through the operation of pressing the button.

As the other electronic apparatus 200 which transmits a broadcast signal is the same, referring to FIGS. 4B and 4C, the form of the UIs 410 and 420 for receiving a connection command, which are displayed by the plurality of electronic apparatuses 100-1, 1002 may be the same. However, the image and shape of the UIs may vary according to the type, producer, display characteristics, etc. of the plurality of electronic apparatuses 100-1, 100-2.

Meanwhile, if information regarding pairing with the other electronic apparatus 200 is received from the other electronic apparatus 200 and yet another (i.e., a third) electronic apparatus, it is controlled such that the UI for receiving a connection command with respect to the other electronic apparatus 200 is no longer displayed.

In other words, referring to FIGS. 4B and 4C, when the UIs 410, 420 for receiving a connection command are displayed on the electronic apparatus 100-1 which is realized as a smart phone and on the smart watch 100-2 simultaneously, if a connection command is input through the UI 420 of the smart watch 100-2, the electronic apparatus 100-1 which is realized as a smart phone may stop displaying the UI 410 for receiving a connection command. Accordingly, the electronic apparatus 100-1 which is realized as a smart phone no longer displays the UI 410.

However, if the functions performed by the other electronic apparatus 200 are controllable by a plurality of electronic apparatuses simultaneously based on analysis result on the type of the other electronic apparatus 200 and apparatus identification information including information regarding the functions performed by the other electronic apparatus 200, the electronic apparatus 100 may keep displaying a UI for receiving a connection command even if information regarding pairing with the other electronic apparatus 200 is received from other electronic apparatuses.

In addition, if the other electronic apparatus 200 is controllable only by one electronic apparatus, the other electronic apparatus 200 may stop broadcasting a signal when pairing with yet another electronic apparatus is completed.

Accordingly, if broadcasting of a signal from the other electronic apparatus 200 is stopped, the electronic apparatus 100 may stop displaying the UI for receiving a connection command even if information on completion of pairing is not received from yet another electronic apparatus.

Meanwhile, when paired with the other electronic apparatus 200, the display 130 may display a control UI for controlling the other electronic apparatus 200.

More specifically, when paired with the other electronic apparatus 200, the controller 120 may control the communicator 110 to receive information regarding control of the functions of the other electronic apparatus 200 from the other electronic apparatus 200. In addition, the controller 120 may control the display 130 to display a control UI corresponding to the received information.

For example, the information regarding control of the functions, which is received from the other electronic apparatus 200 may include at least one of a UI image, a function code for controlling the functions of another electronic apparatus and uniform resource locator (URL) address information for downloading a UI image.

The control UI is a UI for receiving a control command to control the other electronic apparatus 200, which will be described in more detail with reference to FIG. 4D.

If a user command to connect to the other electronic apparatus 200 is input through the UI 410 of the electronic apparatus 100-1 which is realized as a smart phone, the electronic apparatus 100-1 may transmit a pairing signal to the other electronic apparatus 200. For example, the electronic apparatus 100-1 may transmit a pairing signal using a communication method through which a signal including apparatus identification information has been received.

When the electronic apparatus 100-1 transmits a pairing signal to the other electronic apparatus 200 and pairing between the electronic apparatus 100-1 and the other electronic apparatus 200 is completed, the electronic apparatus 100-1 may receive information regarding control of the functions of the other electronic apparatus 200 from the other electronic apparatus 200. Subsequently, the controller 120 may control the display 130 to display a control UI 430 corresponding to the received information.

More specifically, the control UI 430 may include a menu to control the functions executed by the other electronic apparatus 200 which has been paired. For example, the other electronic apparatus 200 may perform a photographing function as illustrated in FIG. 4A and thus, the electronic apparatus 100-1 may display the control UI 430 for setting a photographing environment, which includes a photographing UI 435 for receiving a photographing command.

Meanwhile, the electronic apparatus 100-1 may transmit profile information including information regarding the display 130 while transmitting a pairing signal to the other electronic apparatus 200. More specifically, the size, resolution, specifications, etc. of a display which displays a control UI may vary depending on electronic apparatuses. Accordingly, the electronic apparatus 100-1 may transmit profile information including information regarding the display 130 while transmitting a pairing signal to the other electronic apparatus 200 in order to request a control UI which is appropriate for its display environment.

The other electronic apparatus 200 which receives the pairing signal and the profile information may perform pairing with the electronic apparatus 100-1, and transmit information regarding a function control corresponding to the received profile information.

The other electronic apparatus 200 may transmit a UI image to the electronic apparatus 100-1 as information regarding the function control. However, if the other electronic apparatus 200 may not store a UI image appropriate for the profile information of the corresponding electronic apparatus, or the size of a UI image may be too large to be transmitted.

Thus, the other electronic apparatus 200 may transmit a function code to control the functions of another electronic apparatus or URL address information for downloading a UI image to the electronic apparatus 100-1.

For example, if the other electronic apparatus 200 transmits URL address information for downloading a UI image, the electronic apparatus 100-1 which receives the URL address information may connect to the corresponding URL address and download the UI image.

FIG. 4E illustrates an embodiment in which the smart watch 100-2 displays a control UI 440. In general, the smart watch 100-2 has a display which is smaller than that of the electronic apparatus 100-1 such as a smart phone. Accordingly, the other electronic apparatus 200 which receives profile information regarding the smart watch 100-2 may transmit a control UI which is appropriate to be displayed in the smart watch 100-2.

Accordingly, referring to FIG. 4E, the smart watch 100-2 may display a control UI including only the photographing UI 440 for receiving a photographing command.

FIGS. 4A to 4E are views illustrating various embodiments where the other electronic apparatus 200 is an electronic apparatus which is controllable through the electronic apparatus 100-1 which is realized as a smart phone and the smart watch 100-2.

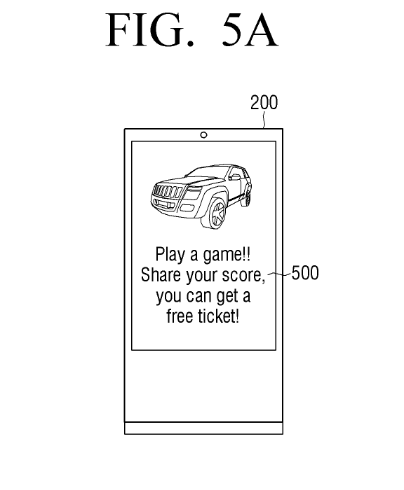

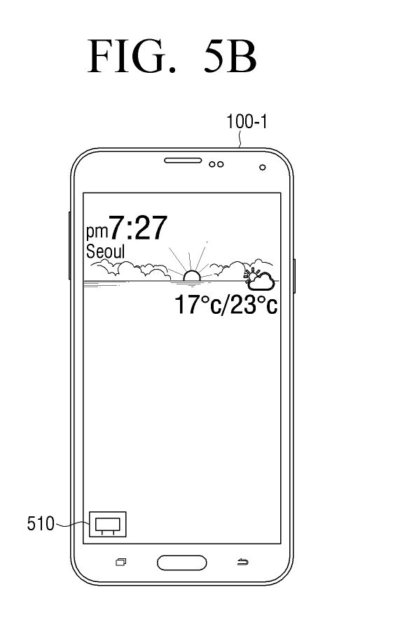

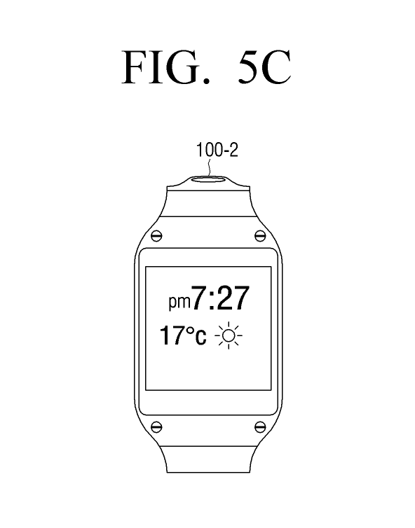

On the other hand, FIGS. 5A to 5C are views illustrating various embodiments where the functions executed in the other electronic apparatus 200 are not controllable through the smart watch 100-2.

FIGS. 5A, 5B, and 5C are views provided to explain a method of displaying a UI in an electronic apparatus according to a function of other electronic apparatuses according to various embodiments of the present disclosure.

More specifically, referring to FIG. 5A, if a car game 500 is executed in the other electronic apparatus 200, the other electronic apparatus 200 may broadcast apparatus identification information including identification for identifying the other electronic apparatus 200 and functions performed in the other electronic apparatus 200 (that is, a car game execution function).

The information regarding a car game execution function may include information regarding the condition that the car game can be controlled by a plurality of apparatuses simultaneously but a controlling electronic apparatus should have a certain size and resolution.

In an embodiment, it is assumed that the display of the electronic apparatus 100-1 which is realized as a smart phone satisfies the condition of the other electronic apparatus 200, but the display of the smart watch 100-2 does not satisfy the condition of the other electronic apparatus 200 regarding the size and resolution.

Accordingly, referring to FIG. 5B, the electronic apparatus 100-1 which is realized as a smart phone may display a UI 510 for receiving a connection command to connect to the other electronic apparatus 200.

On the other hand, referring to FIG. 5C, the smart watch 100-2 does not display a UI for receiving a connection command to connect to the other electronic apparatus 200.

In other words, even when a plurality of electronic apparatuses receive a signal broadcast by another electronic apparatus simultaneously, each electronic apparatus 100-1, 100-2 may determine whether the other electronic apparatus 200 is a controllable apparatus, and only an electronic apparatus which can control the other electronic apparatus 200 may display a UI for receiving a connection command to connect to another electronic apparatus from a user.

Referring back to FIG. 3, the electronic apparatus 100 may include the storage 150. Accordingly, the controller 120 may control the storage 150 to store apparatus identification information regarding another electronic apparatus, which has been received, an input UI, a control UI, etc.

For example, if the image of a control UI is downloaded after pairing with the other electronic apparatus 200 is completed, the electronic apparatus 100 may store the apparatus identification information of the other electronic apparatus 200 which has been paired and the image of the control UI in the storage 150.

Accordingly, if a connection command is input from a user after the same apparatus identification information of the other electronic apparatus 200 is received, the electronic apparatus 100 may transmit only a pairing signal to the other electronic apparatus 200 and may not receive a control UI to control the other electronic apparatus 200. In other words, the electronic apparatus 100 may display a control UI which is stored in the storage 150.

Meanwhile, if a command to connect to the other electronic apparatus 200 is input through a connection UI, the controller 120 may perform pairing with yet another electronic apparatus which is linked to the other electronic apparatus 200 simultaneously.

In other words, if a record of performing pairing with yet another electronic apparatus while performing the pairing with the other electronic apparatus 200 simultaneously is stored in the storage 150, the controller 120 may perform the pairing with the other electronic apparatus 200 and with yet another electronic apparatus simultaneously. For example, if the other electronic apparatus 200 which performs pairing is a PC and there are a printer and a scanner which are linked to the PC, the electronic apparatus 100 which performs pairing with the PC may receive a signal broadcast by the PC to perform pairing with the printer and the scanner as well.

In addition, information regarding the pairing with the printer and the scanner when pairing with the PC may be stored in the storage 150. Accordingly, if pairing with the same PC is performed later to control the same function, the electronic apparatus 100 which performs pairing with the PC may also be paired with the printer and the scanner.

Meanwhile, if a signal is received from a plurality of other electronic apparatuses through the communicator 110, the controller 120 may analyze apparatus identification information included in the signal received from each of the plurality of other electronic apparatuses and determine whether each of the plurality of other electronic apparatuses is controllable by the electronic apparatus 100.

The controller 120 may control the communicator 110 to transmit a pairing signal to another electronic apparatus which is selected by a user from among a plurality of other electronic apparatuses which are controllable by the electronic apparatus 100.

In addition, in order to control the other electronic apparatus 200 which is a single apparatus, each of a plurality of electronic apparatuses 100 may be paired with the other electronic apparatus 200.

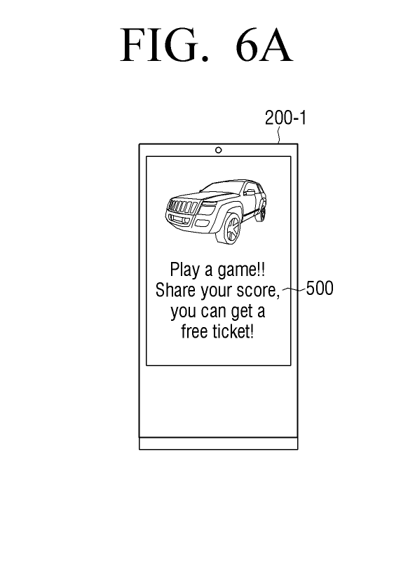

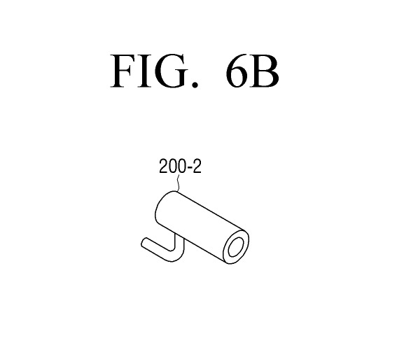

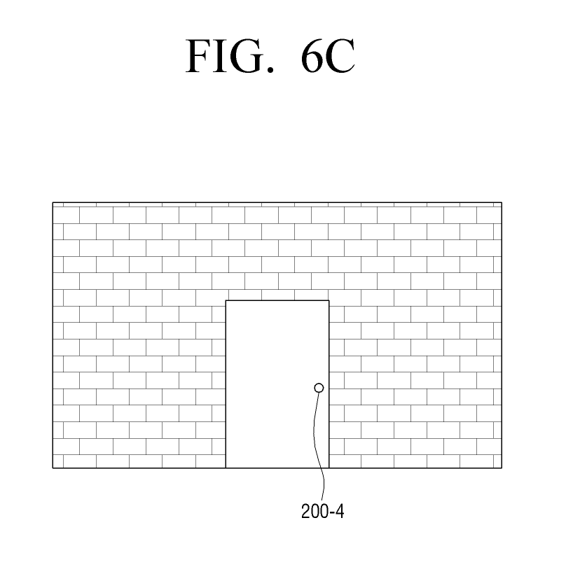

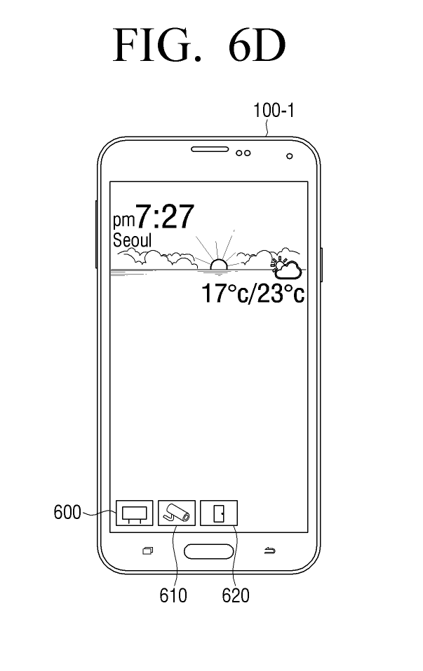

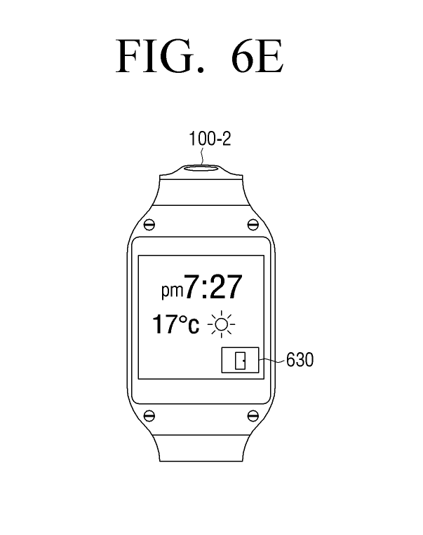

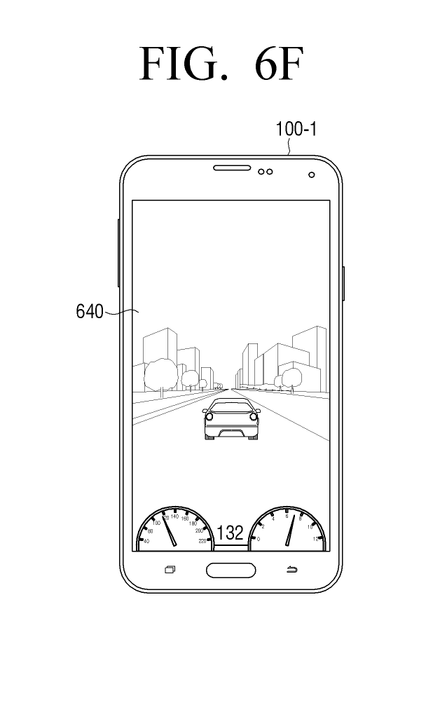

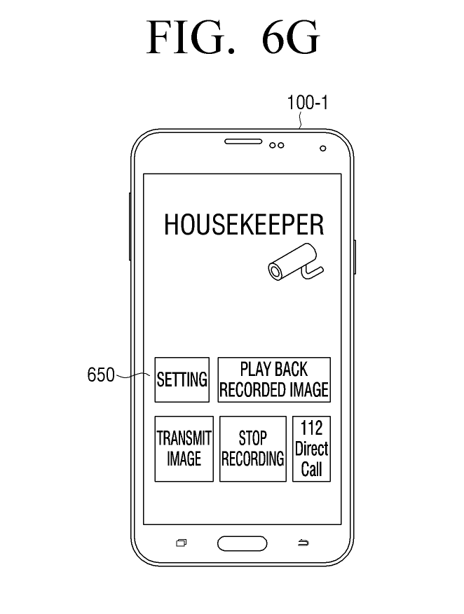

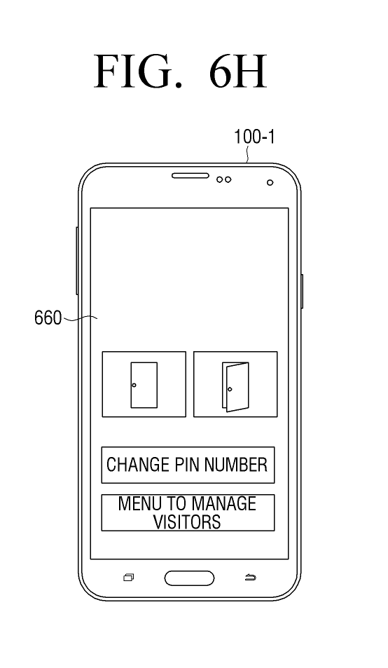

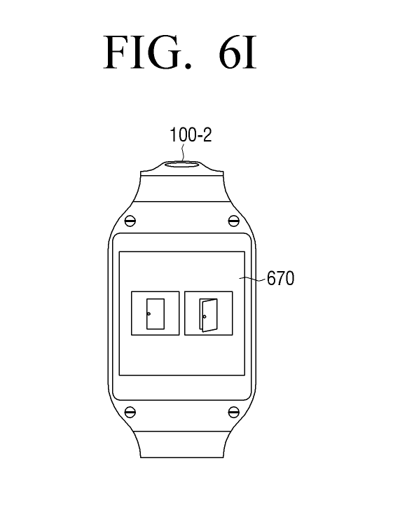

Hereinafter, an embodiment in which there are a plurality of other electronic apparatuses and electronic apparatuses will be described with reference to FIGS. 6A to 6I.

FIGS. 6A, 6B, 6C, 6D, 6E, 6F, 6G, 6H, and 6I are views provided to explain a method where each of a plurality of electronic apparatuses controls at least one of the other apparatuses according to various embodiments of the present disclosure.

Referring to FIG. 6A to 6C, in an embodiment, it is assumed that a user having a smart phone and a smart watch arrives at the front of an office. At the front of the office where the user arrives, there may be an LFD 200-1 which displays a promotion for a car game and its prize as illustrated in FIG. 6A, a CCTV 200-2 for photographing the front of the office as illustrated in FIG. 6B, and a locking device 200-3 which is installed on the office door 200-4 as illustrated in FIG. 6C as other electronic apparatuses.

The plurality of other electronic apparatuses 200-1, 200-2, 200-3 may broadcast a signal including apparatus identification information. In other words, as described above, the plurality of other electronic apparatuses 200-1, 200-2, 200-3 may broadcast a signal which has no restriction on the type of electronic apparatuses which receives the signal.

Meanwhile, referring to FIGS. 6D and 6E, the smart phone 100-1 and the smart watch 100-2, which the user has, analyze apparatus identification information received from the plurality of other electronic apparatuses 200-1, 200-2, 200-3 to determine whether each of the plurality of electronic apparatuses 200-1, 200-2, 200-3 is a controllable electronic apparatus. The method of determining a controllable electronic apparatus is the same as described above.

Referring to FIG. 6D, the display of the smart phone 100-1 has a size which is larger than a certain size and thus, may be large enough to display a control UI including various setting menus. Accordingly, it may be determined that the smart phone 100-1 is capable of controlling a car game which is executed on the LFD 200-1 and controlling the CCTV 200-2 and the locking device 200-3 installed on the door.

Thus, the smart phone 100-1 may display UIs 600, 610, 620 for receiving a connection command with respect to other electronic apparatuses on part of the display. In other words, if a connection command to connect to the LFD 200-1 is input from the user through an LFD connection UI 600, the smart phone 100-1 may transmit a pairing signal to the LFD 200-1.

In addition, if a connection command to connect to the CCTV 200-2 is input from the user through a CCTV connection UI 610, the smart phone 100-1 may transmit a pairing signal to the CCTV 200-2. If a connection command to connect to the locking device 200-2 which is installed on the door is input from the user through a locking device connection UI 620, the smart phone 100-1 may transmit a pairing signal to the locking device 200-3 which is installed on the door.

Meanwhile, referring to FIG. 6E, the smart watch 100-2 has a smaller display than that of the smart phone 100-1 and thus, may be suitable to display a control UI in a simple form.

Accordingly, the smart watch 100-2 may determine that only the locking device 200-3 installed on the door is controllable. As a result, the smart watch 100-2 may display a UI 630 for receiving a connection command with respect to the locking device 200-3 which is installed on the door on part of the display. If a connection command to connect to the locking device 200-3 which is installed on the door is input through the locking device connection UI 630, the smart watch 100-2 may transmit a pairing signal to the locking device 200-3.

If a connection command to connect to another electronic apparatus is input from a user through a connection UI, the electronic apparatus 100 may transmit a pairing signal. In addition, the electronic apparatus 100 may also transmit profile information including information regarding the display of the electronic apparatus 100. More specifically, each electronic apparatus has a different display which displays a UI in terms of size, resolution, specification, etc. Accordingly, when transmitting a pairing signal to the other electronic apparatus 200, the electronic apparatus 100 may transmit profile information including information regarding the display in order to request a control UI which is appropriate for its own display environment.

When the pairing is completed, and a control UI to control the other electronic apparatus 200 is received from the other electronic apparatus 200, each electronic apparatus may display the control UI and receive a control command to control the other electronic apparatus 200.

Referring to FIG. 6F, if a connection command to connect to the LFD 200-1 is input from a user through the LFD connection UI 600, and pairing between the smart phone 100-1 and the LFD 200-1 is completed, the smart phone 100-1 may display a control UI 640 to control a car game which is displayed on the LFD 200-1.

The control UI 640 which is displayed on the smart phone 100-1 may also be displayed on the display of the LFD 200-1 simultaneously. Alternatively, if there are a plurality of electronic apparatuses which are paired with the LFD 200-1 to perform a car game, the control UI 640 which is displayed on the smart phone 100-1 may be displayed on part of the display of the LFD 200-1 along with a control UI which is executed on other electronic apparatuses. If there are a plurality of electronic apparatuses which perform a car game, the LFD 200-1 may display only the result of the car game which is performed in each electronic apparatus.

Referring to FIG. 6G, if a connection command to connect to the CCTV 200-2 is input from a user through the CCTV connection UI 610, and the pairing between the smart phone 100-1 and the CCTV 200-2 is completed, the smart phone 100-1 may display a control UI 650 to control the CCTV 200-2.

For example, the control UI 650 to control the CCTV 200-2 may play back an image which is set or recorded through the CCTV 200-2 or display a menu to transmit the image to yet another electronic apparatus.

Accordingly, by using the smart phone 100-1, the user may easily watch and transmit an image which is photographed by the CCTV 200-2 around his or her office, and may change the setting.

Meanwhile, referring to FIG. 6H, if a connection command to connect to the locking device 200-3 is input from a user through the locking device connection UI 620, and the pairing between the smart phone 100-1 and the locking device 200-3 is completed, the smart phone 100-1 may display a control UI 660 to control the locking device 200-3.

For example, the control UI 660 to control the locking device 200-3 may receive a command to open or close the locking device 200-3. As the display of the smart phone 100-1 is larger than a certain size, the control UI 660 to control the locking device 200-3 may display a menu to change the specific description of the locking device 200-3.

Meanwhile, referring to FIG. 6I, the display of the smart watch 100-2 is remarkably smaller than that of the smart phone 100-1. Accordingly, if a user command to select the locking device connection UI 630 which is displayed on the smart watch 100-2 is input, a control UI 670 receiving only the command to open or close the locking device 200-3 may be displayed.

In other words, the smart phone 100-1 and the smart watch 100-2 may receive a control UI which complies with their own display specifications from another electronic apparatus and display the control UI.

More specifically, the smart phone 100-1 and the smart watch 100-2 may transmit the information regarding their own displays along with a pairing signal to another electronic apparatus. As a result, when the smart phone 100-1 and the smart watch 100-2 are paired with the locking device 200-3, respectively, the locking device 200-3 may transmit information regarding a control UI which is appropriate to be displayed in each electronic apparatus 100-1, 100-2 based on the information regarding the displays of each electronic apparatus 100-1, 100-2 which is received from the locking device 200-3.

Accordingly, the smart phone 100-1 and the smart watch 100-2 may receive a URL address, etc. for downloading the control UIs 660, 670 which are suitable for their displays or the control UIs 660, 670 from the locking device 200-3. Consequently, the control UIs 660, 670 illustrated in FIGS. 6H and 6I are displayed on the smart phone 100-1 and the smart watch 100-2, respectively.

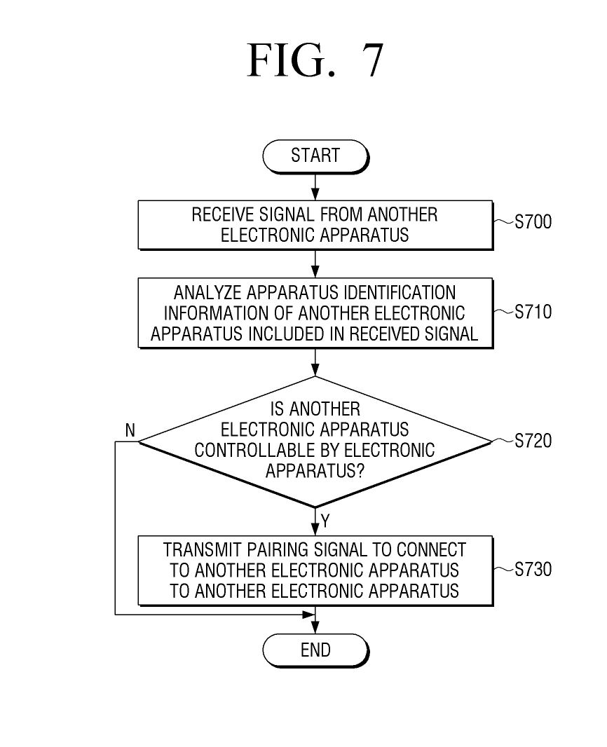

FIG. 7 is a flowchart illustrating a method in which an electronic apparatus connects to another electronic apparatus according to an embodiment of the present disclosure.

Referring to FIG. 7, the electronic apparatus 100 receives a signal from the other electronic apparatus 200 at operation S700. In other words, the other electronic apparatus 200 may receive a signal broadcast from the other electronic apparatus 200.

More specifically, the other electronic apparatus 200 may broadcast a signal which can be received by any electronic apparatus via a network as long as the electronic apparatus is different from the other electronic apparatus 200. According to an embodiment, the signal may be broadcast via network such as Wi-Fi network, Bluetooth network, cellular network, etc.

Accordingly, the electronic apparatus 100 including various communication modules such as a Bluetooth module, a Wi-Fi module, an NFC module, or a wireless communication module may receive a signal broadcast by the other electronic apparatus 200.

The electronic apparatus 100 analyzes apparatus identification information of another electronic apparatus, which is included in the received signal at operation S710, and determines whether the other electronic apparatus 200 is a controllable apparatus at operation S720.

In other words, the received signal may include apparatus identification information including identification to identify the other electronic apparatus 200 and information regarding the functions performed by the other electronic apparatus 200. Accordingly, the electronic apparatus 100 may analyze the apparatus identification information to determine whether the other electronic apparatus 200 can be controlled by the electronic apparatus 100.

More specifically, the electronic apparatus 100 may determine whether the other electronic apparatus 200 is a connectable apparatus based on the identification information of the other electronic apparatus 200, which is included in the received signal. The controller may determine whether the functions of the other electronic apparatus 200 can be controlled by the electronic apparatus 100. Accordingly, if the other electronic apparatus 200 is a connectable apparatus and can be controlled by the electronic apparatus 100, the controller 120 may determine that another electronic the other 200 is a controllable apparatus.

If it is determined that the other electronic apparatus 200 is controllable by the electronic apparatus 100 at operation S720-Y, the electronic apparatus 100 transmits a pairing signal to connect to the other electronic apparatus 200 to the other electronic apparatus 200 at operation S730. For example, the electronic apparatus 100 may transmit a pairing signal using a communication method through which a signal broadcast from the other electronic apparatus 200 has been received.

If the other electronic apparatus 200 receives a pairing signal from the electronic apparatus 100, pairing between the electronic apparatus 100 and the other electronic apparatus 200 is completed.

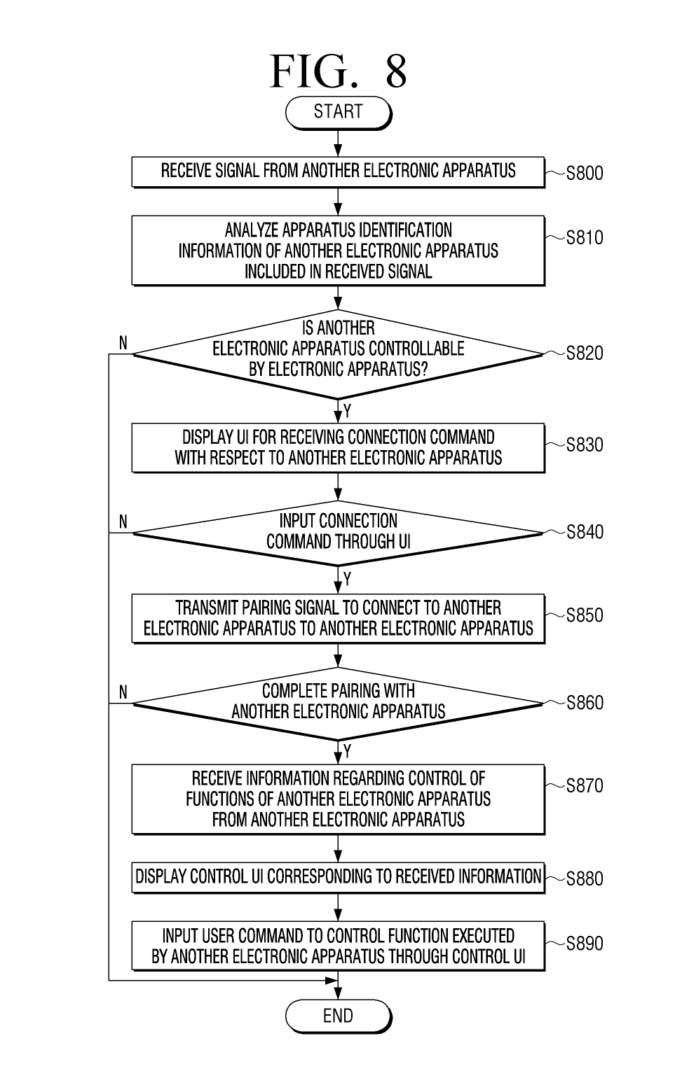

FIG. 8 is a flowchart illustrating a controlling method of an electronic apparatus according to an embodiment of the present disclosure.

Referring to FIG. 8, the electronic apparatus 100 receives a signal from the other electronic apparatus 200 at operation S800. The electronic apparatus 100 analyzes apparatus identification information of the other electronic apparatus 200, which is included in the received signal at operation S810. If it is determined that the other electronic apparatus 200 is controllable by the electronic apparatus 100 at operation S820-Y, the electronic apparatus 100 displays a UI for receiving a connection command with respect to the other electronic apparatus 200 at operation S830. If a connection command is input through the UI at operation S840-Y, the electronic apparatus 100 transmits a pairing signal to connect to the other electronic apparatus 200 to the other electronic apparatus 200 at operation S850.

In other words, the electronic apparatus 100 may display a UI for receiving a connection command, and if a connection command is input through the UI, may transmit a pairing signal.

More specifically, if a connection UI is displayed on a display which is realized as a touch screen, a connection command may be input through a touch command of touching the connection UI using a user's finger or a separate control apparatus such as a stylus pen.

Meanwhile, the connection UI is to inform a user that the other electronic apparatus 200 which is controllable can be connected, and to receive a connection command with respect to the other electronic apparatus 200, and can be realized in any form which may display the information. For example, the electronic apparatus 100 may light a light emitting diode (LED) provided outside the electronic apparatus 100 with a predetermined color to inform a user that the other electronic apparatus 200 which is controllable can be connected. Subsequently, a connection command may be input through a user command of selecting an enter button displayed on the display of the electronic apparatus 100 or an enter button which is provided outside the electronic apparatus 100.

If the pairing with the other electronic apparatus 200 is completed at operation S860-Y, the electronic apparatus 100 receives information regarding control of the functions of the other electronic apparatus 200 from the other electronic apparatus 200 at operation S870. For example, the information regarding control of the functions, which is received from the other electronic apparatus 200 may include at least one of a UI image, a function code to control a function of another electronic apparatus and URL address information to download the UI image.

More specifically, the electronic apparatus 100 may transmit profile information including information regarding the display of the electronic apparatus 100 along with a pairing signal to the other electronic apparatus 200. More specifically, the size, resolution, specifications, etc. of a display which displays a control UI may vary depending on electronic apparatuses. Accordingly, the electronic apparatus 100 may transmit profile information including information regarding the display while transmitting a pairing signal to the other electronic apparatus 200 in order to request a control UI which is appropriate for its display environment. Thus, the other electronic apparatus 200 which receives the pairing signal and the profile information may complete the pairing with the electronic apparatus 100, and transmit information regarding control of a function corresponding to the received profile information.

Meanwhile, the electronic apparatus 100 displays a control UI corresponding to the received information at operation S880. For example, the electronic apparatus 100 may display the received image of a control UI. In addition, the electronic apparatus 100 may connect to the URL address received from the other electronic apparatus 200 to download a control UI image, and display the downloaded control UI.

The control UI is a UI to receive a control command to control the other electronic apparatus 200. Accordingly, the electronic apparatus 100 receives a user command to control the functions executed by the other electronic apparatus 200 through a control UI at operation 890.

For example, if the other electronic apparatus 200 is an air conditioner which is used in a space such as a house or an office, the electronic apparatus 100 which is paired with the air conditioner may display a control UI to control the air conditioner. Accordingly, a user command to control the functions of the air conditioner such as turning on/off, temperature control, and wind intensity control may be input from a user.

The controlling method of an electronic apparatus according to the above-described various embodiments may be coded as software and stored in a non-transitory readable medium which can be mounted and used in various apparatuses.

The non-transitory recordable medium refers to a medium which may store data semi-permanently rather than storing data for a short time, such as register, cache, memory, etc. and is readable by an apparatus. More specifically, the above-described various applications and programs may be stored and provided in a non-transitory recordable medium such as compact disc (CD), digital versatile disc (DVD), hard disk, Blu-ray disk, universal serial bus (USB), memory card, read only memory (ROM), etc.

Although a bus is not illustrated in the above-described block diagram regarding an electronic apparatus, communication between elements of the electronic apparatus may be performed through a bus. In addition, each device may further include a central processing unit (CPU) for performing the above-described various steps and a processor such as a micro processor.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a communicator configured to transmit/receive a signal to/from another electronic apparatus; and
a controller configured to:
receive first information of the other electronic apparatus, the first information including a device identification information and a function identification information corresponding to a function being executed in the other apparatus, and
control the communicator to transmit second information for pairing with the other apparatus to connect to the other electronic apparatus, to the other electronic apparatus, if the function being executed in the other apparatus is controllable in the electronic apparatus.

2. The apparatus as claimed in claim 1, further comprising:
a display configured to, in response to the other electronic apparatus being controllable by the electronic apparatus, display a user interface (UI) to receive a command to connect to the other electronic apparatus,
wherein the controller, in response to receiving the connection command through the UI, controls the communicator to transmit the second information for pairing with the other apparatus.

3. The apparatus as claimed in claim 2, wherein the controller, in response to receiving information that the other electronic apparatus is paired from the other electronic apparatus and another electronic apparatus which is different from the other electronic apparatus, is further configured to stop displaying the UI to receive a command to connect to the other electronic apparatus.

4. The apparatus as claimed in claim 1, wherein the controller is further configured to determine whether the other electronic apparatus is connectable and whether a function of the other electronic apparatus is controllable by the electronic apparatus based on the first information to determine whether the other electronic apparatus is controllable by the electronic apparatus.

5. The apparatus as claimed in claim 1, further comprising:
a display configured to, in response to the other electronic apparatus being paired, display a control UI to control the other electronic apparatus.

6. The apparatus as claimed in claim 5,
wherein the communicator, in response to the other electronic apparatus being paired, is further configured to receive information regarding controlling of a function of the other electronic apparatus from the other electronic apparatus, and
wherein the controller is further configured to control the display to display a control UI corresponding to the received information.

7. The apparatus as claimed in claim 6, wherein the information regarding controlling of a function is at least one of a UI image, a function code to control a function of the other electronic apparatus and URL address information to download the UI image.

8. The apparatus as claimed in claim 1,
wherein the communicator is further configured to transmit/receive a signal to/from a plurality of other electronic apparatuses, and
wherein the controller is further configured to:
analyze the first information received from each of the plurality of other electronic apparatuses to determine whether the each of the plurality of other electronic apparatuses is controllable by the electronic apparatus, and
control the communicator to transmit the second information to another electronic apparatus selected by a user from among the plurality of other electronic apparatuses which are controllable by the electronic apparatus.

9. The apparatus as claimed in claim 8, further comprising:
a display configured to display a UI to select one of the plurality of other controllable apparatuses,
wherein the controller is further configured to control the communicator to transmit the second information to the selected another electronic apparatus.

10. A controlling method of an electronic apparatus, the method comprising:
receiving first information from another electronic apparatus, the first information including a device identification information and a function identification information corresponding to a function being executed in the other apparatus; and
transmitting second information for pairing with the other apparatus to connect to the other electronic apparatus, to the other electronic apparatus, if the function being executed in the other apparatus is controllable in the electronic apparatus.

11. The method as claimed in claim 10, further comprising:
in response to the other electronic apparatus being controllable by the electronic apparatus, displaying a user interface (UI) to receive a command to connect to the other electronic apparatus,
wherein the transmitting comprises, in response to receiving the connection command through the UI, transmitting the pairing signal.

12. The method as claimed in claim 11, wherein the displaying of the UI further comprises, in response to receiving information that the other electronic apparatus is paired from the other electronic apparatus and another electronic apparatus which is different from the other electronic apparatus, stopping the displaying of the UI to receive a command to connect to the other electronic apparatus.

13. The method as claimed in claim 10, wherein the determining comprises determining whether the other electronic apparatus is connectable and whether a function of the other electronic apparatus is controllable by the electronic apparatus based on the first information to determine whether the other electronic apparatus is controllable by the electronic apparatus.

14. The method as claimed in claim 10, further comprising:
in response to the other electronic apparatus being paired, displaying a control UI to control the other electronic apparatus.

15. The method as claimed in claim 14, wherein the displaying of the control UI comprises:
in response to the other electronic apparatus being paired, receiving information regarding controlling of a function of the other electronic apparatus from the other electronic apparatus; and
displaying a control UI corresponding to the received information.

16. The method as claimed in claim 15, wherein the information regarding controlling of a function is at least one of a UI image, a function code to control a function of the other electronic apparatus and URL address information to download the UI image.

17. The method as claimed in claim 10,
wherein the receiving comprises transmitting/receiving a signal to/from a plurality of other electronic apparatuses,
wherein the determining comprises analyzing the first information received from each of the plurality of other electronic apparatuses to determine whether the each of the plurality of other electronic apparatuses is controllable by the electronic apparatus, and
wherein the transmitting comprises transmitting the second information to another electronic apparatus selected by a user from among the plurality of other electronic apparatuses which are controllable by the electronic apparatus.

18. The method as claimed in claim 17, further comprising:
displaying a UI to select one of the plurality of other controllable apparatuses,
wherein the transmitting comprises transmitting the second information to the selected other electronic apparatus.
